(19) United States
(12) Patent Application Publication
(10) Pub. No.: US 2025/0230833 A1
(43) Pub. Date: Jul. 17, 2025

(54) Nut Fastening Clip and Nut Fastening Clip Assembly Comprising Same

(71) Applicant: Illinois Tool Works Inc., Glenview, IL (US)

(72) Inventors: Zheng LUO, Shanghai (CN); Zhilin LI, Shanghai (CN); Haijie YU, Shanghai (CN)

(21) Appl. No.: 19/021,640

(22) Filed: Jan. 15, 2025

(30) Foreign Application Priority Data
Jan. 15, 2024 (CN) 202410057948.4
Dec. 6, 2024 (CN) 202423015508.7

(51) Int. Cl. F16B 39/22

(52) U.S. Cl. CPC F16B 39/22

(57) ABSTRACT

The present disclosure provides a nut fastening clip, including: a base plate, a threaded sleeve and a clip body. The threaded sleeve defines an opening and extends downwardly from the base plate. The clip body defines a cavity, and includes a pair of first side walls and a pair of retaining portions. The first side walls are connected to the base plate, each of the first side walls having a window thereon. The pair of retaining portions protrude outwardly from an interior of the cavity through the windows, wherein the pair of retaining portions are configured to be resiliently deflectable relative to each other. The nut fastening clip of the present disclosure may be first securely connected to a first panel so as to be pre-mounted as a nut fastening clip assembly, and then the nut fastening clip assembly is integrally snap-fitted with a second panel.

### RELATED APPLICATIONS

The present application claims the benefit of Chinese Patent Application Nos. 202410057948.4, filed Jan. 15, 2024, and 202423015508.7, filed Dec. 6, 2024, each titled “Nut Fastening Clip and Nut Fastening Clip Assembly Comprising Same,” the contents of which are hereby incorporated by reference.

### BACKGROUND

In recent years, holders have been developed for fastening a plurality of panels to each other. For example, a vehicle includes various panels (e.g., a metal plate or a plastic plate) that are connected to each other to form a vehicle body, a vehicle door and an interior of the vehicle. Some existing fastening clips are configured to fixedly connect other parts or plates together by screwing fastening bolts into the fastening clips.

### SUMMARY

The present disclosure relates generally to a nut fastening clip, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a nut fastening clip according to one embodiment of the present disclosure from one perspective.

FIG. 1B is a perspective view of the nut fastening clip shown in FIG. 1A from another perspective.

FIG. 1C is a front view of the nut fastening clip shown in FIG. 1A.

FIG. 1D is a top view of the nut fastening clip shown in FIG. 1A.

FIG. 2A is a cross-sectional view of the nut fastening clip shown in FIG. 1C along line A-A.

FIG. 2B is a cross-sectional view of the nut fastening clip shown in FIG. 1D along line B-B.

FIG. 2C is a cross-sectional view of the nut fastening clip shown in FIG. 1D along line C-C.

FIG. 3A is a perspective view of the nut fastening clip of FIG. 1A from one perspective with a resilient leg retracted.

FIG. 3B is a perspective view of the nut fastening clip shown in FIG. 3A from another perspective.

FIG. 3C is a cross-sectional view of the nut fastening clip shown in FIG. 3A.

FIGS. 4A-4C show the structure of a nut fastening clip assembly including the nut fastening clip shown in FIG. 1A and a first panel.

FIGS. 5A-5D show a process for assembling the nut fastening clip assembly shown in FIG. 4B to a second panel.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

In a first aspect, the present disclosure provides a nut fastening clip, including a base plate, a threaded sleeve and a clip body. The threaded sleeve defines an opening and extends downwardly from the base plate. The clip body defines a cavity, and includes: a pair of first side walls and a pair of retaining portions. The first side walls are connected to the base plate, each of the first side walls having a window thereon. The pair of retaining portions protrude outwardly from an interior of the cavity through the windows, wherein the pair of retaining portions are configured to be resiliently deflectable relative to each other.

According to the first aspect described above, the nut fastening clip further includes a pair of resilient legs connected to the pair of first side walls, respectively, each of the resilient legs including a corresponding one of the retaining portions. A bottom end of the resilient leg is connected to a corresponding one of the pair of first side walls, and a top end of the resilient leg is a free end to enable the pair of retaining portions to be resiliently deflected.

According to the first aspect described above, the resilient leg further includes an upper leg portion and a lower leg portion, and the retaining portion connects the upper leg portion and the lower leg portion. A bottom portion of the lower leg portion is provided within the cavity and connected to an inner side of the bottom of the first side wall, and the lower leg portion extends obliquely outwardly from the bottom portion to the retaining portion, so as to allow the lower leg portion to extend obliquely outwardly from an inner side of the first side wall to pass through the window.

According to the first aspect described above, the first side wall includes a stepped support, and the stepped support is arranged in the window and is configured such that a width of the window above the stepped support is greater than a width of the window below the stepped support. The upper leg portion extends transversely from the retaining portion through the window into the cavity, and the upper leg portion has a greater width than the lower leg portion to allow the upper leg portion to be supported on the stepped support.

According to the first aspect described above, the clip body further includes a pair of second side walls, the pair of second side walls and the pair of first side walls being each arranged opposite each other and being connected to each other to form the cavity, wherein a space is provided between the second side wall and the base plate. Each of the resilient legs includes an operating portion located within the cavity and connected to the upper leg portion of the resilient leg, wherein the operating portion is exposed through the space.

According to the first aspect described above, each of the upper leg portions includes a bent portion and/or a connecting portion. The bent portion is arranged in the cavity, wherein the bent portion extends downwardly from the upper leg portion to the inner side of the first side wall below the window. The connecting portion is arranged in the cavity, wherein the connecting portion extends upwardly to the inner side of the first side wall above the window and is connected to the operating portion.

According to the first aspect described above, the bottom portions of the lower leg portions of the pair of resilient legs abut against each other.

According to the first aspect described above, the retaining portion includes a resilient tab, the resilient tab having an outer end connected to the retaining portion and an inner end forming a free end. The resilient tab is formed by extending obliquely upwardly and inwardly from an upper surface of the retaining portion.

According to the first aspect described above, the resilient tab includes a protrusion formed by protruding upwardly from an upper surface of the resilient tab.

In a second aspect, the present disclosure provides a nut fastening clip assembly, including: a first plate, a nut fastening clip according to any one of the embodiments in the first aspect, and a bolt. The first plate has a first assembling hole. The bolt has an external thread. The bolt is engageable with a threaded sleeve of the nut fastening clip by means of the external thread thereof so as to pass through the first assembling hole to securely connect the first plate to the nut fastening clip.

In a third aspect, the present disclosure provides a nut fastening clip system, including: a nut fastening clip assembly according to the second aspect, and a second plate. The second plate has a second assembling hole. The nut fastening clip is configured to be snap-fitted in the second assembling hole of the second plate.

Other objectives and advantages of the present disclosure will be apparent from the following description of the present disclosure with reference to the drawings, which can contribute to a comprehensive understanding of the present disclosure.

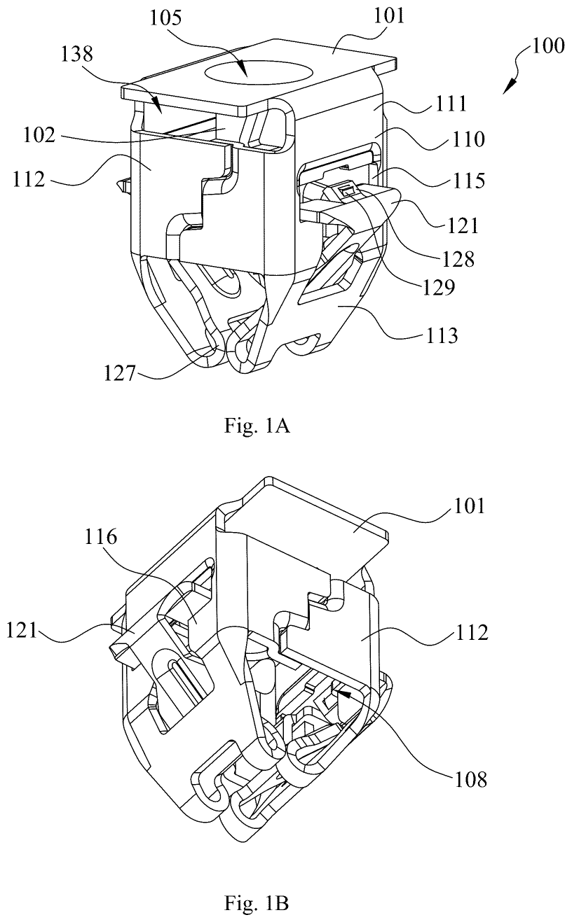

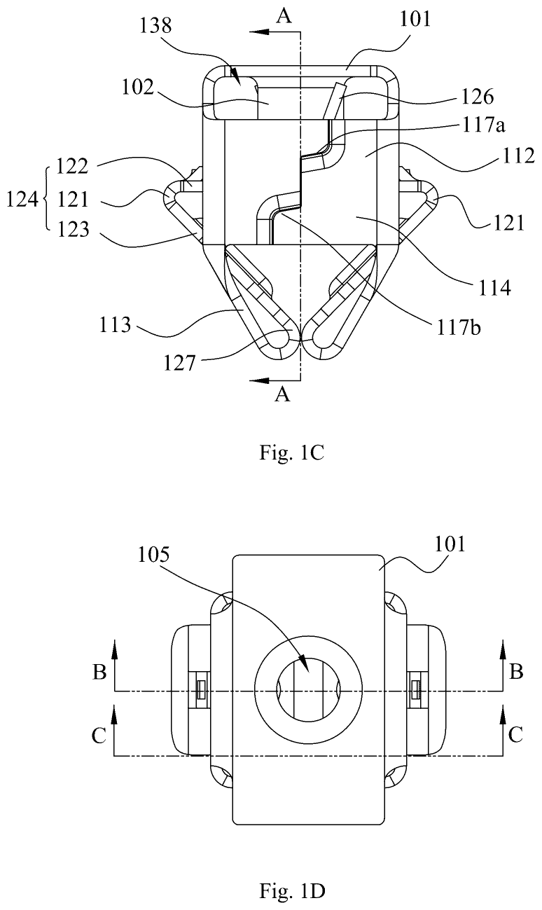

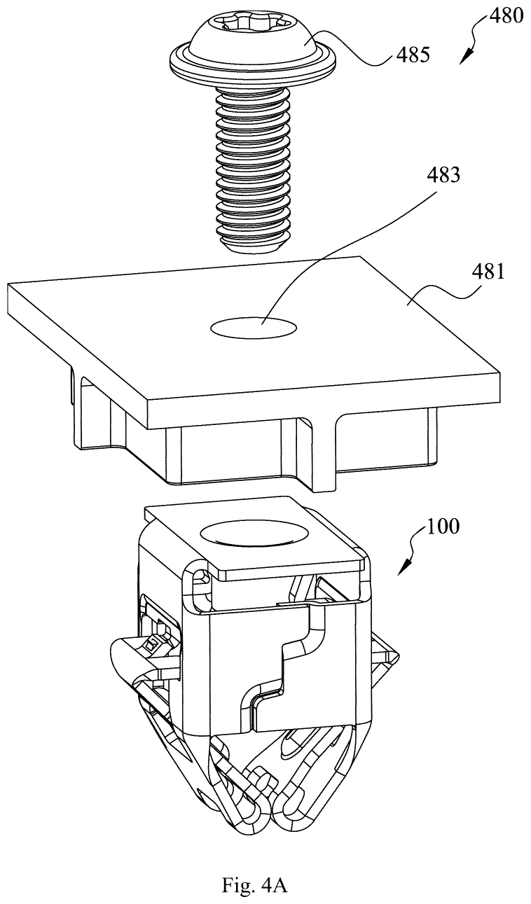

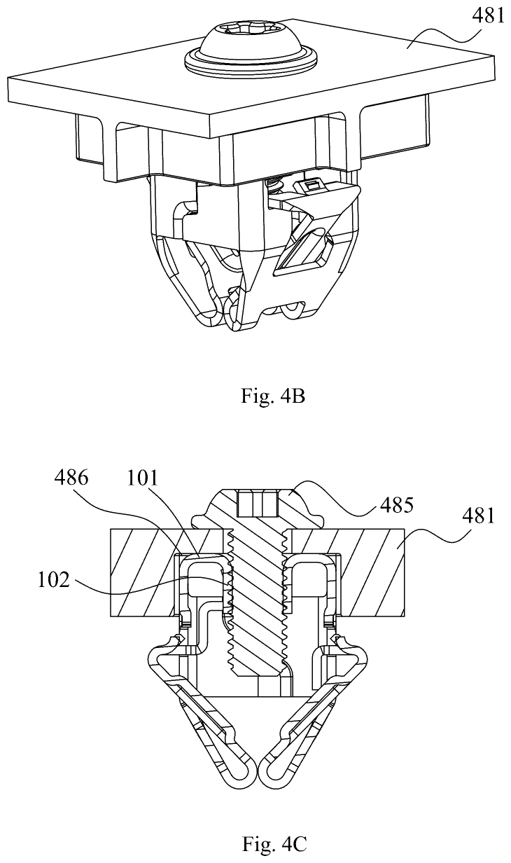

FIGS. 1A-1D show the basic structure of a nut fastening clip 100 according to one embodiment of the present disclosure. FIG. 1A shows a structural perspective view of the nut fastening clip 100 from one perspective, FIG. 1B shows a structural perspective view of the nut fastening clip 100 from another perspective, FIG. 1C shows a front view of the nut fastening clip 100, and FIG. 1D shows a top view of the nut fastening clip 100. As shown in FIGS. 1A-1D, the nut fastening clip 100 includes a base plate 101, a threaded sleeve 102, and a clip body 110. The clip body 110 is connected to a lower surface of the base plate 101, and the threaded sleeve 102 is formed by extending downwardly from the lower surface of the base plate 101. In this embodiment, the base plate 101 is substantially in the shape of a rectangular plate, the threaded sleeve 102 is formed by extending downwardly from the middle of the base plate 101, and the threaded sleeve 102 defines an opening 105 on the base plate 101. The interior of the threaded sleeve 102 has an internal thread. The threaded sleeve 102 can receive, through the opening 105, a threaded fastener such as a bolt 485 having an external thread, to securely connect the first plate 481 to the nut fastening clip 100 (see FIGS. 4A-4C). The threaded fastener engages with the internal thread of the threaded sleeve.

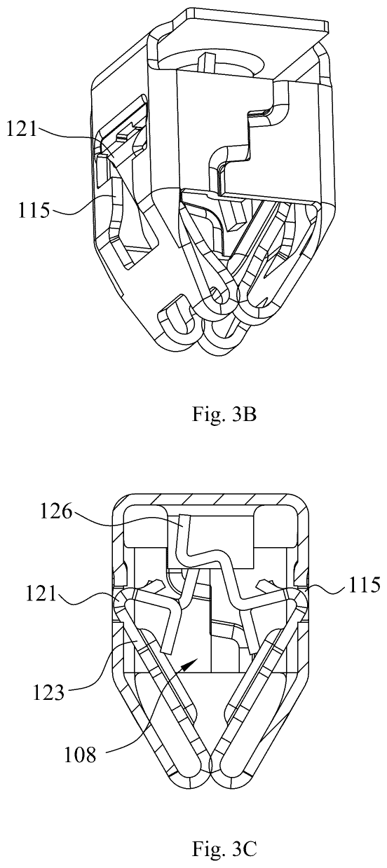

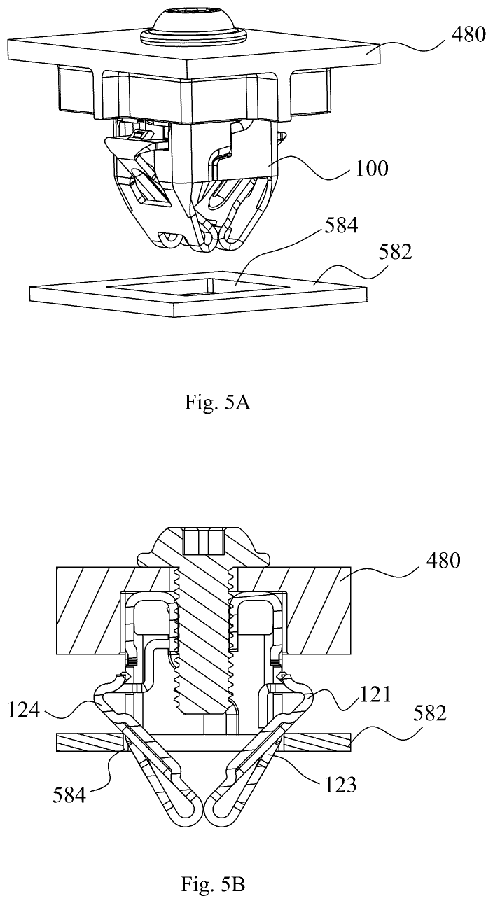

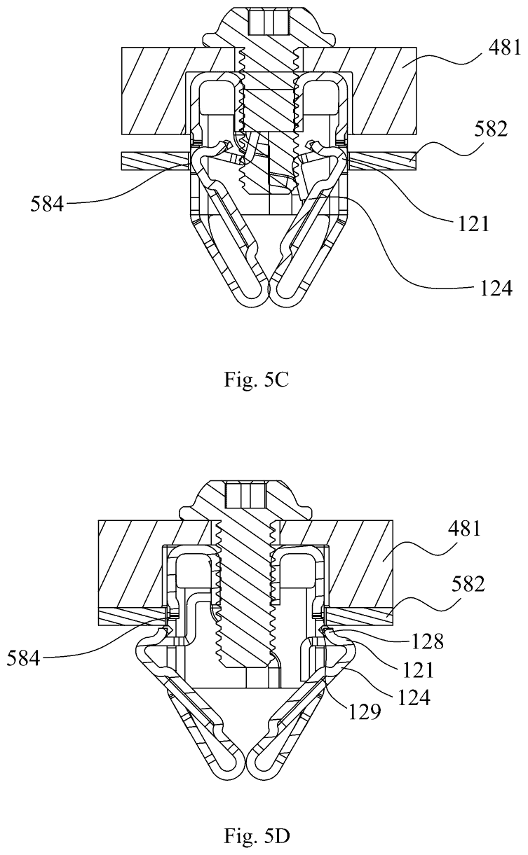

The clip body 110 is connected to the underside of the base plate 101. The clip body 110 includes a pair of oppositely arranged first side walls 111 and a pair of oppositely arranged second side walls 112. The pair of first side walls 111 and the pair of second side walls 112 are connected to each other to enclose a substantially square cavity 108. In this embodiment, the pair of first side walls 111 are connected to long-side plate edges of the base plate 101 and are formed by extending downwardly from the long-side plate edges of the base plate 101. A distance between the pair of second side walls 112 is less than the length of the long side of the base plate 101. That is, the base plate 101 can extend beyond the second side wall 112. In this way, when the nut fastening clip 100 is snap-fitted with a second plate 582, the second side walls 112 can pass through a second assembling hole 584 of the second plate 582, and the base plate 101 is snap-fitted on the second plate 582 (see FIGS. 5A-5D). Each first side wall 111 has a downwardly extending extension portion 113 and each first side wall 111 is provided with a window 115. The window 115 penetrates through the first side wall 111. The clip body 110 further includes a pair of resilient legs 124, each resilient leg 124 including a retaining portion 121. The retaining portion 121 protrudes outwardly from the interior of the cavity 108 through the window 115. In some embodiments, the extension portion 113 extends obliquely inwardly in a top-to-bottom direction. The pair of resilient legs 124 are correspondingly connected to the pair of first side walls 111. Specifically, a bottom end of the resilient leg 124 is connected to the bottom of the extension portion 113, and a top end of the resilient leg 124 is a free end, so that the resilient leg 124 can have elasticity. This will enable the retaining portions 121 to be resiliently deflectable relative to each other. For example, the pair of retaining portions 121 can be deflected during assembling of the nut fastening clip, so as to be retracted through the windows 115 into the cavity 108 as shown in FIGS. 3A-3C, or return to the positions protruding from the first side walls 111 as shown in FIGS. 1A-1D when assembled in place. When assembled in place, the pair of retaining portions 121 can hold, in place, the second plate 582 to be assembled (see FIG. 5D).

More specifically, each resilient leg 124 includes an upper leg portion 122, a retaining portion 121, and a lower leg portion 123. A bottom portion 127 of each lower leg portion 123 is connected to a corresponding extension portion 113, and the lower leg portion 123 is arranged substantially on an inner side of the extension portion 113. Each lower leg portion 123 is extended obliquely outwardly in a bottom-to-top direction so that the lower leg portion 123 gradually extends obliquely outwardly from the inner side of the extension portion 113 to pass through the window 115, and is thus connected to the bottom of the retaining portion 121 protruding from the first side wall 111. In this embodiment, the bottom portion 127 of each lower leg portion 123 is in the shape of a circular arc, and the bottom portions 127 of the pair of lower leg portions 123 abut against each other. This arrangement prevents the resilient legs 124 from contracting and deforming inwardly, to increase the retaining force of the nut fastening clip when it is assembled in place. Those skilled in the art may also provide a hollowed-out structure of a certain size on the bottom portion 127 to reduce the retaining force according to specific needs.

The upper leg portion 122 is connected to one side of the top of the retaining portion 121 and is arranged to extend transversely through the window 115 back into the interior of the cavity 108. In this embodiment, the lower portion of the window 115 is narrowed than the upper portion thereof, to form a stepped support 116. The resilient leg 124 is configured in a corresponding shape, that is, the lower leg portion 123 is narrowed relative to the upper leg portion 122 so that the corresponding portions of the resilient leg 124 can pass through the window 115. That is, the upper leg portion 122 passes through the window 115 above the stepped support 116, and the lower leg portion 123 passes through the window 115 below the stepped support 116. In this embodiment, the stepped support 116 has a substantially horizontal step shape, and the upper leg portion 122 extends substantially horizontally and is supported on the stepped support 116.

In this way, when the lower leg portion 123 is subjected to an upward pressure, a transverse force component can be created on the obliquely extending lower leg portion 123, causing the resilient leg 124 to contract inwardly. When the upper leg portion 122 is subjected to a downward pressure, the upper leg portion 122 can be supported by the stepped support 116 without deforming the resilient leg 124, thereby increasing the retaining force of the nut fastening clip 100 when it is assembled in place.

In this embodiment, each retaining portion 121 further includes a resilient tab 128. One end of the resilient tab 128 is connected to the top of the retaining portion 121 and the other end thereof is a free end, so that the resilient tab 128 has a certain elasticity. The resilient tab 128 is formed by extending obliquely upwardly and inwardly from the top of the retaining portion 121 so that the resilient tab 128 is inclined substantially upwardly relative to the upper leg portion 122. The resilient tab 128 is configured to compensate for manufacturing tolerances and assembly tolerances of the panel to be assembled and the nut fastening clip 100, to ensure that the retaining portion 121 can be at least partially in contact with the second assembling hole 584 in the second plate 582 to be assembled, to retain, in place, the second plate 582 to be mounted (see FIG. 5D). In this embodiment, the retaining portion 121 further includes a protrusion 129. The protrusion 129 is provided on an upper surface of the resilient tab 128 and protrudes upwardly from the upper surface of the resilient tab 128. The protrusion 129 is configured to further compensate for the manufacturing tolerance of the nut fastening clip 100. It will be appreciated by those skilled in the art that in some embodiments, it is not needed to provide the protrusion 129.

The pair of second side walls 112 of the clip body 110 are connected only to the pair of first side walls 111 and not to the base plate 101, and an upper surface of each second side wall 112 is spaced apart from the lower surface of the base plate 101 by a space 138. Each resilient leg 124 further includes an operating portion 126. The operating portion 126 is connected to an upper portion of the upper leg portion 122 and located in the cavity 108. The operating portion 126 is exposed through the space 138 between the second side wall 112 and the base plate 101 so that an operator can apply a force to the operating portion 126 by means of a tool or the like reaching into the cavity 108 via the space 138, forcing the resilient leg 124 to resiliently deform. In this way, the operator can remove the nut fastening clip 100.

In this embodiment, each second side wall 112 is formed by splicing and engaging two splice plates 114. The two splice plates 114 have complementary stepped shapes and are staggered in the inner and outer directions. In the second side wall 112 as shown in FIG. 1C, a top step face 117a of the left splice plate 114 is provided on an outer side of a top step face of the right splice plate 114, and a bottom step face of the left splice plate 114 is provided on an inner side of a bottom step face 117b of the right splice plate 114. In this way, the second side wall 112 can have a better strength to better support the first side wall 111 when the clip body 110 is subjected to force.

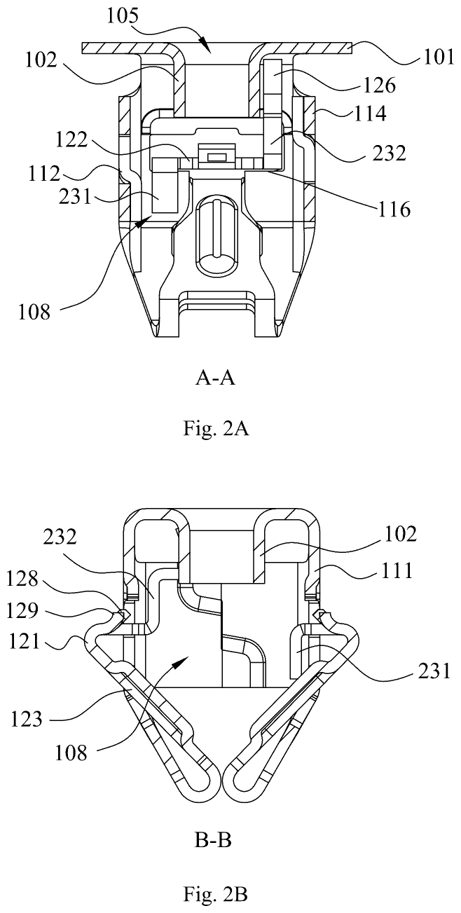

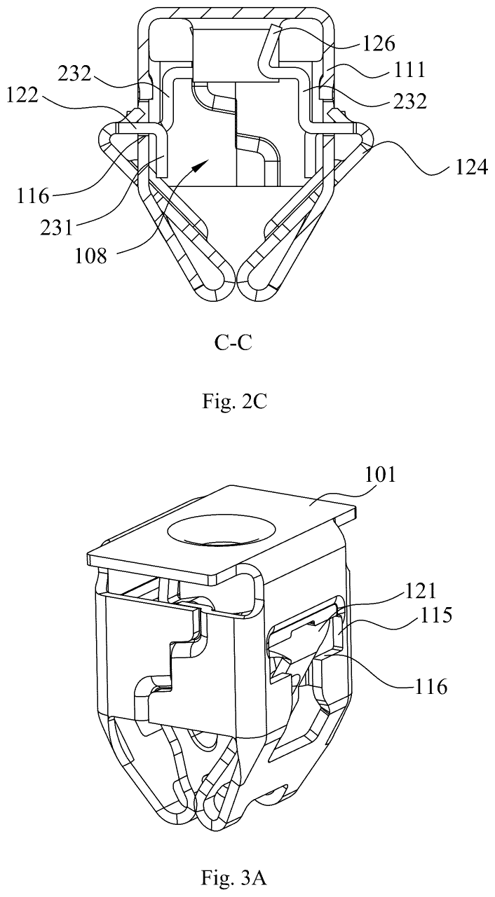

FIGS. 2A-2C show a more detailed structure of the nut fastening clip 100. FIG. 2A is a cross-sectional view of the nut fastening clip 100 along line A-A, FIG. 2B is a cross-sectional view of the nut fastening clip 100 along line B-B, and FIG. 2C is a cross-sectional view of the nut fastening clip 100 along line C-C. As shown in FIGS. 2A-2C, the upper leg portion 122 includes, at the top, a bent portion 231 and a connecting portion 232. The connecting portion 232 is configured to connect the operating portion 126 to the resilient leg 124. In this embodiment, the bent portion 231 and the connecting portion 232 are both arranged in the cavity 108 and on two sides with respect to the top of the upper leg portion 122, i.e., adjacent to the pair of second side walls 112, respectively. For example, from the perspective as shown in FIG. 2A, the bent portion 231 is arranged on a left side of the upper leg portion 122 and the connecting portion 232 is arranged on a right side of the upper leg portion 122. The bent portions 231 and the connecting portions 232 of the pair of resilient legs 124 have substantially the same shape and structure, but are located in opposite positions. That is, the bent portion 231 of one of the resilient legs 124 is opposite the connecting portion 232 of the other resilient leg 124, and the connecting portion 232 of the one resilient leg 124 is opposite the bent portion 231 of the other resilient leg 124. The bent portion 231 is formed by bending downwardly from the top of the upper leg portion 122 and extending perpendicular thereto. The operating portion 126 is arranged at a top end of the connecting portion 232. In this embodiment, the connecting portion 232 is formed by extending upwardly from the top of the upper leg portion 122 and then extending inwardly, and the operating portion 126 is formed by extending obliquely upwardly and outwardly from the top end of the connecting portion 232. In this way, the bent portion 231 can hook to the inner side of the first side wall 111 below the window 115, and the connecting portion 232 can hook to the inner side of the first side wall 111 above the window 115, thereby preventing the resilient leg 124 from being pulled out outwardly, and further increasing the retaining force of the nut fastening clip 100. From the perspectives as shown in FIG. 2C, when the operator applies a leftward force to the operating portion 126 on the right side of the figure, the right resilient leg 124 can be deflected inwardly, causing the retaining portion 121 to retract into the window 115 and the cavity 108. Similarly, the operator applies a rightward force to the left operating portion (which is shielded by the threaded sleeve 102 and cannot be seen in FIG. 2C), forcing the left resilient leg 124 to be deflected inwardly.

FIGS. 3A-3C show the specific structure of the nut fastening clip 100 with the resilient leg 124 retracted and deformed inwardly. FIGS. 3A and 3B show perspective views of the nut fastening clip 100 with the resilient leg 124 retracted inwardly and deformed. FIG. 3C shows a cross-sectional view of the nut fastening clip 100 taken along line C-C in FIG. 1D. As shown in FIGS. 3A-3C, when the resilient leg 124 is retracted or contracted inwardly, the retaining portion 121 of the resilient leg 124 is retracted through the window 115 into the cavity 108 and the window 115, no longer protruding from the first side wall 111, so that the nut fastening clip 100 can move up and down in the second assembling hole 584 of the second plate 582. Those skilled in the art can use a number of ways to facilitate deformation of the resilient leg 124. For example, either when the operating portion 126 of the resilient leg 124 is pushed by the operator or when the lower leg portion 123 is pressed upwardly, the resilient leg 124 can be pushed to retract or contract inwardly.

FIGS. 4A-4C show the structure of a nut fastening clip assembly 480 including a nut fastening clip 100 and a first plate 481. FIG. 4A shows an exploded view of the nut fastening clip assembly 480, FIG. 4B shows a perspective view of the nut fastening clip assembly 480, and FIG. 4C shows a cross-sectional view of the nut fastening clip assembly 480 taken along line B-B in FIG. 1D. As shown in FIGS. 4A-4C, the nut fastening clip assembly 480 includes the nut fastening clip 100, the first plate 481 and a bolt 485. The first plate 481 has a circular first assembling hole 483 penetrating therethrough, and a lower surface of the first plate 481 has a recess 486. The recess 486 has a shape and size substantially corresponding to those of the base plate 101 of the nut fastening clip 100, for receiving the top of the nut fastening clip 100. The bolt 485 has an external thread. The external thread of the bolt 485 engages with the internal thread in the threaded sleeve 102 of the nut fastening clip 100, so that the bolt 485 can be securely connected to the nut fastening clip 100, and the first plate 481 can be securely connected to the nut fastening clip 100 by means of the bolt 485. The bolt 485 is inserted into the threaded sleeve 102 through the first assembling hole 483 of the first plate 481 and then through the opening 105 of the nut fastening clip 100, such that the nut fastening clip 100 abuts against the bottom of the recess 486 of the lower surface of the first plate 481, and the top of the bolt 485 abuts against an upper surface of the first plate 481. In this way, the first plate 481 and the nut fastening clip 100 are securely connected together by means of the bolt 485 to form the nut fastening clip assembly 480. In some embodiments, the first plate 481 is a plastic protective plate of a vehicle.

FIGS. 5A-5D show a process for assembling the nut fastening clip assembly 480 to the second plate 582. FIG. 5A shows a structural perspective view of the nut fastening clip assembly 480 aligned with the second plate 582, FIGS. 5B and 5C show cross-sectional views of the nut fastening clip assembly 480 and the second plate 582 during assembly taken along line B-B in FIG. 1D, and FIG. 5D shows cross-sectional views of the nut fastening clip assembly 480 and the second plate 582 assembled in place taken along line B-B in FIG. 1D. As shown in FIG. 5A, the second plate 582 has a square second assembling hole 584. The size of the second assembling hole 584 is substantially the same as the size of the clip body 110 of the nut fastening clip 100. When the operator assembles the nut fastening clip assembly 480 to the second plate 582, the nut fastening clip assembly 480 is first aligned from above with the second assembling hole 584 of the second plate 582. The operator then applies a downward pressure to the nut fastening clip assembly 480, causing the nut fastening clip 100 to be inserted downwardly into the second assembling hole 584. The extension portion 113 of the bottom of the nut fastening clip 100 is inserted into the second assembling hole 584 first, so that the nut fastening clip assembly 480 and the second plate 582 reach the position as shown in FIG. 5B.

As shown in FIG. 5B, the lower leg portion 123 of the nut fastening clip 100 abuts against a hole edge of the second assembling hole 584. Since the retaining portion 121 of the nut fastening clip 100 protrudes from the first side wall 111 and the size of the second assembling hole 584 is designed to correspond to that of the clip body 110, the retaining portion 121 will be blocked by the second assembling hole 584, so that the second assembling hole 584 blocks the nut fastening clip 100 from continuing downward movement relative to the second panel 582.

If the operator continues to apply the downward pressure, the hole edge of the corresponding second assembling hole 584 will press the lower leg portion 123 of the nut fastening clip 100 to create a force component that forces the lower leg portion 123 to retract inwardly in the position where the hole edge of the second assembling hole 584 abuts against the lower leg portion 123. This force component forces the resilient legs 124 of the nut fastening clip 100 to contract and deform inwardly and the pair of retaining portions 121 to deflect inwardly relative to each other until the nut fastening clip assembly 480 and the second plate 582 reach the position as shown in FIG. 5C.

As shown in FIG. 5C, the resilient leg 124 of the nut fastening clip 100 is contracted and deforms inwardly, and the retaining portion 121 is retracted into the cavity 108 and the window 115, no longer protruding from the first side wall 111. In this way, the hole edge of the second assembling hole 584 no longer blocks the continued downward movement of the nut fastening clip 100 relative to the second plate 582. As the operator continues to apply the downward pressure, the nut fastening clip assembly 480 and the second plate 582 reach the position as shown in FIG. 5D.

As shown in FIG. 5D, in this state, the nut fastening clip assembly 480 and the second plate 582 are assembled in place, and the second plate 582 abuts against the first plate 481, so that the first plate 481 and the second plate 582 are connected together. The resilient leg 124 of the nut fastening clip 100 passes through the second assembling hole 584 of the second plate 582 to the underside of the second plate 582. The resilient leg 124 is no longer pressed by the hole edge of the second assembling hole 584, so that the resilient leg 124 can return to its uncontracted initial state. In this case, at least a part of the retaining portion 121 abuts against the second plate 582 from below, and clamps the second plate 582 together with the first plate 481 to retain the first plate 481 and the second plate 582 in place, so that the second panel 582 cannot move up or down relative to the nut fastening clip 100. As an example, when assembled in place, the upper leg portion 122 of the resilient leg 124 is located below the second plate 582 and is not in contact with the second plate 582. The resilient tab 128 or the protrusion 129 of the retaining portion 121 abuts against the hole edge of the second assembling hole 584 of the second plate 582 to retain the first plate 481 and the second plate 582 in place. Since the resilient tab 128 has a certain elasticity, such an arrangement can allow the first plate 481, the second plate 582 and the nut fastening clip 100 to have a certain manufacturing tolerance, and allow for assembly tolerance. Therefore, even after the second plate 582 abuts against the first plate 481 and has a distance from the upper leg portion 122 of the resilient leg 124, it is possible to remain the resilient tab 128 or the protrusion 129 of the retaining portion 121 in abutment with the resilient leg 124 of the nut fastening clip 100, to achieve a stable connection between the first plate 481 and the second plate 582. In some embodiments, the second plate 582 is sheet metal of the vehicle.

After the nut fastening clip assembly 480 and the second plate 582 have been assembled, if it is necessary to remove the nut fastening clip assembly 480 from the second plate 582, the operator may first remove the bolt 485 to remove the first plate 481 from the upper side of the second plate 582 and the nut fastening clip 100. The operator then forces the resilient leg 124 to be deformed by pressing the operating portion 126, and after the retaining portion 121 is retracted into the cavity 108 and the window 115, the nut fastening clip 100 can be removed from the second plate 582.

The panel described in the present disclosure may refer to any component that can be attached or assembled to another component. Any panel described in the present disclosure may be made of any suitable material, such as a metal or plastic material. Moreover, the nut fastening clip of the present disclosure may be made of a plastic or metal material.

The present disclosure provides a nut fastening clip for securely connecting two or more panels together. The nut fastening clip includes both a threaded sleeve configured for connection with a bolt and a clip body configured for resilient snap-fit with a panel, so that the nut fastening clip can meet the use requirements of panels of various thicknesses and have a wider application.

Moreover, in the nut fastening clip of the present disclosure, by setting the matching shapes of the resilient legs and the stepped support, and making the bottoms of the resilient legs abut against each other, the nut fastening clip can have a greater retaining force, so that a secure connection is provided. If the nut fastening clip is made of a metal material, the retaining force of the nut fastening clip can reach 4000 N or more.

Furthermore, the nut fastening clip of the present disclosure may be first securely connected to a first panel so as to be pre-assembled as a nut fastening clip assembly, and then the nut fastening clip assembly is integrally snap-fitted with a second panel, especially when the first plate is the plastic protective plate of the vehicle, and the second plate is the sheet metal of the vehicle. An original equipment manufacturer of the vehicle usually wants to minimize the assembly time on a final assembly line. In the present disclosure, the nut fastening clip is pre-assembled to the plastic protective plate, so that the time for securely connecting a bolt on the final assembly line of the original equipment manufacturer can be eliminated, saving on the assembling time on the final assembly line of the original equipment manufacturer of the vehicle, thereby improving the production efficiency and economic benefits of the original equipment manufacturer.

Although the present disclosure is described with respect to the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting. Therefore, the present disclosure in this specification may be used to solve other technical problems and may have other technical effects. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

What is claimed is:

1. A nut fastening clip, comprising:
a base plate;
a threaded sleeve defining an opening and extending downwardly from the base plate; and
a clip body defining a cavity, the clip body comprising:
a pair of first side walls connected to the base plate, each of the first side walls having a window thereon; and
a pair of retaining portions protruding outwardly from an interior of the cavity through the windows, wherein the pair of retaining portions are configured to be resiliently deflectable relative to each other.

2. The nut fastening clip according to claim 1, wherein
the nut fastening clip further comprises a pair of resilient legs connected to the pair of first side walls, respectively, each of the resilient legs comprising a corresponding one of the retaining portions;
wherein a bottom end of the resilient leg is connected to a corresponding one of the pair of first side walls, and a top end of the resilient leg is a free end to enable the pair of retaining portions to be resiliently deflected.

3. The nut fastening clip according to claim 2, wherein
the resilient leg further comprises an upper leg portion and a lower leg portion, and the retaining portion connects the upper leg portion and the lower leg portion;
wherein a bottom portion of the lower leg portion is provided within the cavity and connected to an inner side of the bottom of the first side wall, and the lower leg portion extends obliquely outwardly from the bottom portion to the retaining portion, so as to allow the lower leg portion to extend obliquely outwardly from an inner side of the first side wall to pass through the window.

4. The nut fastening clip according to claim 3, wherein
the first side wall comprises a stepped support, and the stepped support is arranged in the window and is configured such that a width of the window above the stepped support is greater than a width of the window below the stepped support;
wherein the upper leg portion extends transversely from the retaining portion through the window into the cavity, and the upper leg portion has a greater width than the lower leg portion to allow the upper leg portion to be supported on the stepped support.

5. The nut fastening clip according to claim 3, wherein
the clip body further comprises a pair of second side walls, the pair of second side walls and the pair of first side walls being each arranged opposite to each other and being connected to each other to form the cavity, wherein a space is provided between the second side wall and the base plate; and
each of the resilient legs comprises an operating portion located within the cavity and connected to the upper leg portion of the resilient leg, wherein the operating portion is exposed through the space.

6. The nut fastening clip according to claim 5, wherein
each of the upper leg portions comprises a bent portion arranged in the cavity, wherein the bent portion extends downwardly from the upper leg portion to the inner side of the first side wall below the window; and/or
a connecting portion arranged in the cavity, wherein the connecting portion extends upwardly to the inner side of the first side wall above the window and is connected to the operating portion.

7. The nut fastening clip according to claim 3, wherein
the bottom portions of the lower leg portions of the pair of resilient legs abut against each other.

8. The nut fastening clip according to claim 3, wherein
the retaining portion comprises a resilient tab, the resilient tab having an outer end connected to the retaining portion and an inner end forming a free end; and
the resilient tab is formed by extending obliquely upwardly and inwardly from an upper surface of the retaining portion.

9. The nut fastening clip according to claim 8, wherein
the resilient tab comprises a protrusion formed by protruding upwardly from an upper surface of the resilient tab.

10. A nut fastening clip assembly, comprising:
a first plate having a first assembling hole;
a nut fastening clip according to claim 1; and
a bolt having an external thread;
wherein the bolt is engageable with a threaded sleeve of the nut fastening clip by means of the external thread thereof so as to pass through the first assembling hole to securely connect the first plate to the nut fastening clip.

11. A nut fastening clip system, comprising:
a nut fastening clip assembly according to claim 10; and
a second plate having a second assembling hole;
wherein the nut fastening clip is configured to be snap-fitted in the second assembling hole of the second plate.
